(19) United States
(12) Patent Application Publication
(10) Pub. No.: US 2012/0160617 A1
(43) Pub. Date: Jun. 28, 2012

(54) BAGGAGE CASTER LOCK DEVICE

(75) Inventors: RUI CHENG QI, SAITAMA (JP); SHOJI HASHIMOTO, SAITAMA (JP)

(73) Assignee: T & S CO., LTD., SAITAMA (JP)

(21) Appl. No.: 13/337,169

(22) Filed: Dec. 26, 2011

(30) Foreign Application Priority Data
Dec. 27, 2010 (JP) 2010-289699
Nov. 15, 2011 (JP) 2011-249348

(51) Int. Cl. B60T 7/02; B60B 33/00

(52) U.S. Cl. 188/1.12

(57) ABSTRACT

A baggage lock device to halt rotation of caster wheels as the handle is retracted, and allow the wheels to move as the handle is pulled out. The device has a receptacle with a handle extendable to be pulled put. A wheel halting mechanism has a traction cord inhibiting wheel rotation by a force pressed against the wheel as operation of an operation mechanism is transmitted via a pulling force transmission mechanism having a pulled wire, a brake pad, a linking member, and means for restoring the position of the operated elements.”.

### BACKGROUND OF THE INVENTION

(a) Field of the Invention

The present invention relates to a caster lock device for locking the casters of baggage such as suitcases movable by means of the casters to inhibit the baggage itself from moving by pushing in and housing the handle having been pulled out and extended for moving.

(b) Prior Art

Prior art caster lock devices for locking the casters rotatably mounted on baggage have been proposed in order to inhibit movable baggage such as suitcases from moving. For example, Patent Document 1 discloses a travel bag; Patent Document 2, a four-wheeled bag; and Patent Document 3, a carry bag with a handle. In the travel bag of the Patent Document 1, the head of a pin is pressed against the circumference of the roller of a caster provided at the bottom of a travel bag by means of the resilience of a spring, and a Bowden wire provided to the handgrip to be pulled as the handgrip is pulled up serves to release the pressure of the pin against the caster roller. In the four-wheeled bag of the Patent Document 2, a push-button is provided on a vertically extendable handgrip of the bag and a rod vertically moving as the push-button is operated abuts a wheel to stop the run. In the carry bag with a handle of the Patent Document 3, an extendable handle is attached to the handle mount of the carry bag, and as the extendable handle is retracted, a cylindrical brake member around the upper part of the caster abuts the wheel against the resilient bias force of a coil spring.

### [Prior Art Documents]

### [Patent Documents]

### [Patent Document 1] JP 11-56438 A;

### [Patent Document 2] JP 2008-272316 A; and

### [Patent Document 3] JP 2010-66328 A.

With the above prior art lock structures, the handgrip of the travel bag of the Patent Document 1 is not extendable and therefore is not applicable to suitcases having a carry structure with an extendable pullout handle/handgrip. The four-wheeled bag of the Patent Document 2 requires an intentional stop operation using the push-button to stop the run while the handgrip of the extendable handgrip device is retracted/housed, which is troublesome. In the carry bag with a handle of the Patent Document 3, the vertical movement of the cylindrical brake member which abuts the wheel surface is caused by extension/retraction of the extendable handle via a brake lever provided directly below the extendable handle and oscillated by leverage. Therefore, the extendable handle is large in width and clumsy. If the extendable handle is reduced in width, the distance between the wheels at the bottom of the carry bag cannot be large, which may not ensure a stable run.

### SUMMARY OF THE INVENTION

The present invention provides a caster lock device for baggage provided with a receptacle, an extendable handle that can be pulled out of or housed in the receptacle by a user, and casters provided on the bottom of the receptacle for making said receptacle easily movable, comprising: an operation mechanism associated with an operation to pull or house said handle out of or in said receptacle; a pulling force transmission mechanism having a transmission element that is pulled by means of said operation mechanism as said handle is operated to be housed; and a wheel halting mechanism for converting a pulling force that is transmitted by said pulling force transmission mechanism to a pressing force applied to at least one wheel of said casters to bring said wheel to a halt, wherein said wheel halting mechanism includes a restoring means exerting resilience to restore said transmission element to the original position as said handle is operated to pull out of said receptacle so as to cancel the pressing force applied to said wheel of said caster.

In order to resolve the above-mentioned problems, the present invention provides a caster lock device 10 for baggage 1 such as a suitcase provided with an extendable handle 2 that can be pulled out and retracted and made movable by means of casters 5, comprising an operation mechanism 11, 21, 31, 41, or 51 (abbreviated as 11 hereafter in the specification) associated with extension/retraction of the handle 2 with respect to the receptacle 1a of the baggage 1 and operated as the handle 2 is retracted/stored, and a wheel halting mechanism 61, 71, 81, 91, 101, 111, or 121 (abbreviated as 61 hereafter in the specification) inhibiting the rotation of a wheel by mean of a halting force pressing on/arresting the outer or inner surface of the wheel of a caster 5 for braking as the operation of the operation mechanism 11 is transmitted via a pulling force transmission mechanism 9 provided with a pulled wire and cancelling the braking action by means of a restoring part 68, 76, 86, 96, 105, 117 (abbreviated as 68 hereafter in the specification).

Furthermore, the wheel halting mechanism 61 may become operable via the pulling force transmission mechanism 9 as the handle 2 housed in a handle housing 201 of the receptacle 1a is further pushed down. In other words, the caster 5 is not locked when the handle 2 is at the first housing depth 201a where the upper surface of the grip 212 of the handle 2 is flush with the upper edge of the receptacle 1a of the baggage, and is locked and its rotation is inhibited when the handle 2 is further pushed down in the handle housing 201 to the second housing depth 201b.

A first operation mechanism 11 may consist of an operation member 12 provided either on the front face or on the back face of the upper part of the handle 2 and protruding from the surface of the handle 2, and an oscillating pull lever 13 oscillating as the operation member 12 moves down and to which the pulling force transmission mechanism 9 transmitting the oscillation to the wheel halting mechanism 61 is linked, wherein the oscillating pull lever 13 is rotatably supported nearly at the center so that when one end is oscillated downward by the operation member 12, the other end linked to the pulling force transmission mechanism 9 is oscillated upward to pull the pulling force transmission mechanism 9.

A second operation mechanism 21 may consist of an operation member 22 provided either on the right side or on the left side of a leg in the upper part of the handle 2 and protruding from the surface of the handle 2, and an oscillating pull lever 23 oscillating as the operation member 22 moves down and to which the pulling force transmission mechanism 9 transmitting the oscillation to the wheel halting mechanism 61 is linked, wherein the oscillating pull lever 23 is rotatably supported nearly at the center so that when one end is oscillated downward by the operation member 22, the other end linked to the pulling force transmission mechanism 9 is oscillated upward to pull the pulling force transmission mechanism 9.

A third operation mechanism 31 may consist of an operation member 32 provided on a side of the upper part of the handle 2 and protruding from the surface of the handle 2, a vertically movable traction bar 33 moving down when pushed by the operation member 32 moving down and to which the pulling force transmission mechanism 9 transmitting the downward motion to the wheel halting mechanism 61 is linked, and a vertical slide guide 34 guiding the vertically movable traction bar 33 in the vertical direction, wherein the operation member 32 and vertically movable traction bar 33 are provided either on the front face or on the back face of a leg in the upper part of the handle 2 and the vertical slide guide 34 is fixed to the receptacle 1a.

A fourth operation mechanism 41 may consist of an operation member 42 provided on any side of the upper part of the handle 2 and protruding from the surface of the handle 2, a vertically movable traction bar 43 moving down when pushed by the operation member 42 moving down and to which the pulling force transmission mechanism 9 transmitting the downward motion to the wheel halting mechanism 61 is linked, and a vertical slide guide 34 guiding the vertically movable traction bar 33 in the vertical direction, wherein the operation member 42 and vertically movable traction bar 43 are provided either on the right side or on the left side of a leg in the upper part of the handle 2 and the vertical slide guide 34 is fixed to the receptacle 1a.

A fifth operation mechanism 51 may consist of an operation member 52 provided either on the front face or on the back face of the upper part of the handle 2 and protruding from the surface of the handle 2, a vertically movable traction board 53 extending between the right and left legs of the handle 2 and to which the pulling force transmission mechanism 9 transmitting to the wheel halting mechanism 61 is linked, and a vertical slide guide 55 guiding the vertically movable traction board 53 in the vertical direction, wherein the vertically movable traction board 53 has a nearly mountain-like guide protrusion 54 protruding downward at the center and the guide protrusion 54 slides vertically along the vertical slide guide 55 provided to the receptacle 1a of the baggage 1.

A first wheel halting mechanism 61 may comprise a flexible traction cord 62 extending through the base of the caster 5 at the center of the rotation plane at the base of the caster 5 and linked to an end of the pulling force transmission mechanism 9, a brake pad 63 fixed to an end of the traction cord 62 and pressing on the inner surface of the wheel as a result of traction of the traction cord 62, a linking member 64 linking the traction cord 62 to the pulling force transmission mechanism 9, and a restoring part 68 resiliently biasing the traction cord 62 to move the brake pad 63 away from the inner surface of the wheel.

It is possible that the linking member 64 has a wire coupling part 65 in the upper part and a cord coupling part 66 in the lower part, the wire coupling part 65 is used to clamp and screw a wire end of the pulling force transmission mechanism 9, and the cord coupling part 66 is used to securely screw (67) the upper end part of the traction cord 62 rotatably inserted therein at positions inside and outside the inserted part of the traction cord 62.

A second wheel halting mechanism 71 may comprise a driving traction bar 72 extending through the base of the caster 5 at the center of the rotation plane at the base of the caster 5 and linked to an end of the pulling force transmission mechanism 9, an oscillating lever 73 rotatably supported within the caster 5 and at an end of which the driving traction bar 72 is pivotally supported, a driven traction bar 74 pivotally supported by the oscillating lever 73 in a vertically movable manner and moving up and down in the same direction as the driving traction bar 72 as the oscillating lever 73 oscillates, a brake pad 75 coupled to the lower end of the driven traction bar 74 and pressing on the inner surface of the wheel of the caster 5, and a restoring part 76 resiliently biasing the driving traction bar 72 to move the brake pad 75 away from the inner surface of the wheel.

A third wheel halting mechanism 81 may comprise a driving traction bar 82 extending through the base of the caster 5 at the center of the rotation plane at the base of the caster 5 and linked to an end of the pulling force transmission mechanism 9, an oscillating lever 83 rotatably supported within the caster 5 and at an end of which the driving traction bar 82 is pivotally supported, a pressure halt bar 84 pivotally supported by the oscillating lever 83 in a vertically movable manner and moving up and down in the opposite direction to the driving traction bar 82 as the oscillating lever 83 oscillates, a brake pad 85 coupled to the lower end of the pressure halt bar 84 and pressing on the outer surface of the wheel of the caster 5 at a nearly top position, and a restoring part 86 resiliently biasing the driving traction bar 82 to move the brake pad 85 away from the outer surface of the wheel.

A fourth wheel halting mechanism 91 may comprise a driving traction bar 92 extending through the base of the caster 5 at the center of the rotation plane at the base of the caster 5 and linked to an end of the pulling force transmission mechanism 9, an oscillating lever 93 rotatably supported within the caster 5 and at an end of which the driving traction bar 92 is pivotally supported, a pressure halt bar 94 pivotally supported by the oscillating lever 93 in a vertically movable manner and moving up and down in the opposite direction to the driving traction bar 92 as the oscillating lever 93 oscillates, a brake pad 95 coupled to the lower end of the pressure halt bar 94 and pressing on the outer surface of the wheel of the caster 5 at a slightly diagonally upper position, and a restoring part 96 resiliently biasing the driving traction bar 92 to move the brake pad 95 away from the outer surface of the wheel.

A fifth wheel halting mechanism 101 may comprise a driving traction bar 102 vertically movable in an operation chamber 8D formed laterally next to an installation chamber 8A formed inside the receptacle 1a above the position where the caster 5 is mounted and linked to an end of the pulling force transmission mechanism 9, an oscillating lever 103 rotatably supported within the installation chamber 8A and at an end of which the driving traction bar 102 is pivotally supported, a pressure halt bar 104 pivotally supported by the oscillating lever 103 in a vertically movable manner, extending through the base of the caster 5 at the center of the rotation plane at the base of the caster 5 to move up and down in the opposite direction to the driving traction bar 102 as the oscillating lever 103 oscillates, and having a lower end arresting the outer surface of the wheel of the caster 5, and a restoring part 105 resiliently biasing the driving traction bar 102 to move the pressure halt bar 104 away from the outer surface of the wheel.

It is possible that the operation chamber 8D is continued from the installation chamber 8A as an integrated compartment and the oscillating lever 103 is positioned closer to the operation chamber 8D and pivotally supported within the installation chamber 8A.

A sixth wheel halting mechanism 111 may comprise a slide cord 112 coupled to the pulling force transmission mechanism 9 in the manner that it slides back and forth within an installation chamber 8A formed inside the receptacle 1a of the baggage 1 above the position where the caster 5 is mounted, a pressing member 113 coupled to the slide cord 112 and having a bottom surface gradually inclined downward toward the rear end of the slide cord 112 to form a sliding surface 114, an oscillated lever 115 oscillating downward as the sliding surface 114 of the pressing member 113 slides forward, a pressure halt bar 116 extending through the base of the caster 5 at the center of the rotation plane at the base of the caster 5 and having a lower end arresting the outer surface of the wheel of the caster 5, and a restoring part 117 resiliently biasing the pressure halt bar 116 to move the pressure halt bar 116 away from the outer surface of the wheel.

A seventh wheel halting mechanism 121 may comprise the sixth wheel halting mechanism 111 in which a brake pad 122 pressing on the outer surface of the wheel of the caster 5 is coupled to the lower end of the pressure halt bar 116.

In the baggage caster lock device 10 having the above structure according to the present invention, as the extendable handle 2 is retracted/stored in the receptacle 1a of the baggage 1, the operation mechanism 11 of the caster lock device 10 operates to cause the brake pad 63, 75, 85, 95, 122 or pressure halt bar 101, 116 of the wheel halting mechanism 61 to arrest or press on the wheel of the caster 5 via the pulled pulling force transmission mechanism 9 for braking, stopping the move/run of the baggage 1. On the other hand, as the handle 2 is pulled out and extended following the braking, the restoring part 68 of the wheel halting mechanism 61 cancels the braking action, allowing the wheel to rotate smoothly.

Furthermore, when the handle 2 is housed in the handle housing 201 to the first housing depth 201a, for example to the position where the upper surface of the grip 212 of the handle 2 is flush with the upper edge of the receptacle 1a of the baggage, the caster 5 is not locked and the baggage 1 is allowed to move/run while the handle 2 remains housed to that position.

When the handle 2 is further pushed in the handle housing 201 to the second housing depth 201b, the caster 5 is locked and its rotation is inhibited. With such a structure, the baggage 1 can selectively be moved or halted depending on whether the handle 2 is pulled out, housed in the handle housing 201 to the first housing depth, or housed in the handle housing 201 to the second housing depth 201b.

In the first and second operation mechanisms 11 and 12, the descent of the operation member 12 or 22 as the handle 2 is retracted/stored causes the oscillating pull lever 13 or 23 to oscillate and pull the pulling force transmission mechanism 9 so that the wheel halting mechanism 61 brakes the wheel of the caster 5.

In the third and fourth operation mechanisms 31 and 42, the operation member 32 or 42 descending as the handle 2 is retracted/stored directly causes the vertically movable traction bar 33 or 43 to move down and the downward motion results in pulling the pulling force transmission mechanism 9 so that the wheel halting mechanism 61 brakes the wheel of the caster 5.

In the fifth operation mechanism 51, the operation member 52 descending as the handle 2 is retracted/stored directly causes the vertically movable traction board 53 extending between the legs of the handle 2 to move down without tilting and such smooth downward motion results in pulling the transmission motion 9 so that the wheel halting mechanism 61 brakes the wheel of the caster 5.

In the first wheel halting mechanism 61, the flexible traction cord 62 maintains the freedom of rotation in any direction of the caster 5 having a rotatable caster structure and, regardless of in which direction the wheel is oriented, the brake pad 63 provided on the inner surface of the wheel is pulled via the pulling force transmission mechanism 9 so as to brake the wheel.

The linking member 64 employs the wire coupling part 65 to clamp and screw the wire of the pulling force transmission mechanism 9 and the cord coupling part 66 for secure screwing (67) at positions inside and outside the inserted part of the linking member 64, ensuring further firm linkage between the pulling force transmission mechanism 9 and traction cord 62.

Furthermore, the linking member 64 couples the traction cord 62 rotatably with respect to the wire coupling part 65 screwing the pulling force transmission mechanism 9 by means of the cord coupling part 66; therefore, the wheel of the caster 5 having a rotatable caster structure can be braked without interference with the rotation.

The driving traction bar 72, 82, or 92 inserted in the base of the caster 5 at the center of the rotation plane in the second through fourth wheel halting mechanisms 71, 81, and 91 or the pressure halt bar 104 or 116 in the fifth through seventh wheel halting mechanisms 101, 111, and 121 is inserted in the base of the caster 5 at the center of the rotation plane; therefore, even the caster 5 having a rotation caster structure has the wheel braked regardless of in which direction the caster 5 rotates.

In the second wheel halting mechanism 71, the oscillating lever 73 making a lever motion causes the brake pad 75 pulled in the same direction as the traction direction of the pulling force transmission mechanism 9 to press on the inner surface of the wheel so as to brake the wheel.

In the third and fourth wheel halting mechanisms 81 and 91, the oscillating lever 83 or 93 making a lever motion causes the brake pad 85 or 95 moved via the pressure halt bar 84 or 94 for pressing on in the opposite direction to the traction direction of the pulling force transmission mechanism 9 to press on the outer surface of the wheel from directly above or from slightly diagonally above so as to brake the wheel.

In the fifth wheel halting mechanism 101, the oscillating lever 103 making a lever motion and linking the wire of the pulling force transmission mechanism 9 pulled to transmit the operation and the pressure halt bar 104 arresting the outer surface of the wheel of the caster 5 converts traction of the pulling force transmission mechanism 9 to pressure of the pressure halt bar 104 on the wheel, pressing on the wheel and braking the wheel. Furthermore, the oscillating lever 103 is provided in an operation chamber 8D inside the receptacle 1a of the baggage 1, ensuring the lever motion.

In the sixth and seventh wheel halting mechanisms 111 and 121, the sliding surface 114 of the pressing member 113 that slides back and forth via the slide cord 112 as a result of traction of the pulling force transmission mechanism 9 oscillates the oscillated lever 115 and this oscillation causes the pressure halt bar 116 and further the brake pad 122 to arrest and press on the wheel of the caster 5 so as to brake the wheel.

### [Efficacy of the Invention]

The present invention has the structure as described above. Then, in the baggage 1 such as a suitcase movable by the extendable pullout handle 2 as the wheel of the caster 5 rotates, as the handle 2 is retracted/stored, the wheel is automatically braked/halted via the operation member 12 of the caster lock device 10. Furthermore, as the handle 2 is pulled out/extended, the wheel is allowed to move/run.

In other words, this is because the caster lock device 10 of the present invention comprises the operation mechanism 11 associated with extension/retraction of the handle 2 and operated when the handle is retracted/stored, and the wheel halting mechanism 61 inhibiting the rotation of the wheel by means of a halting force pressing on/arresting the outer or inner surface of the wheel of the caster 5 as the operation of the operation mechanism 11 is transmitted via the pulling force transmission mechanism 9 provided with a pulled wire and canceling the inhibition of the rotation. Consequently, the wheel of the caster 5 can be braked or rotated according to whether the handle 2 is pulled out or stored.

Furthermore, the wheel halting mechanism 61 is operable via the transmission element 9 that is pulled when the handle 2 housed in the handle housing 201 of the receptacle 1a of the baggage 1 to the first housing depth 201a is further pushed down to the second housing depth 201b. The move and halt of the baggage 1 is associated only with the operation to move the handle 2 up and down. Furthermore, the move or halt is selected simply by moving the handle 2 up and down within the handle housing 201, significantly improving the usability.

Furthermore, provided with a pulled wire, the pulling force transmission mechanism 9 can reach multiple casters 5 regardless of their position on the bottom by extending the wire from the upper part of the receptacle 1a where the handle 2 is provided to the bottom of the receptacle la where the caster 5 is provided along the outer wall of the receptacle 1a of the baggage 1. Then, the operation of the operation mechanism 11 can reliably be transmitted to the wheel halting mechanism 61.

The operation mechanism 11, in which the operation member 12, 22, 32, 42, or 52 provided on the handle 2 moving vertically to be pulled out or stored moves vertically together with the handle 2 and, when the handle 2 is retracted/stored, the operation member 12 or 22 oscillates the oscillating pull lever 13 or 23 or the operation member 32, 42, or 52 moves down the vertically movable traction bar 33 or 43 or vertically movable traction board 53, can reliably cause the wheel halting mechanism 61 to operate via the pulling force transmission mechanism 9.

The wheel halting mechanism 61 inhibits the rotation of the wheel by means of the brake pad 63, 75, 85, 95, or 122 or pressure halt bar 104 or 116 arresting or pressing on the inner or outer surface of the rotating wheel of the caster 5, reliably braking the wheel.

Furthermore, in the wheel halting mechanism 61, the pulling force transmission mechanism 9 and traction cord 62, driving traction bar 72, 82, 92, or 102, and slide cord 112 are linked by the linking member 64 or 143. Therefore, the pulling force transmission mechanism 9 and wheel halting mechanism 61 can be designed separately and assembled in the receptacle 1a of the baggage 1; a variety of caster lock device 10 can be assembled through a variety of combinations.

The restoring part 68, 76, 86, 96, 105, or 117 of the wheel halting mechanism 61 cancels the braking action of the brake pad 63, 75, 85 95, or 122 or pressure halt bar 104 or 116 pressing on or arresting the wheel as the handle 2 is pulled out/extended for moving the baggage 1 while the wheel of the caster 5 is braked, allowing the wheels to rotate smoothly.

The traction cord 62 of the first wheel halting mechanism 61 is flexible and can follow the rotation of the caster 5 even if the caster 5 has a rotatable caster structure. Then, the traction cord 62 causes the brake pad 63 to press on the wheel from inside of the wheel regardless of the rotation direction of the wheel, ensuring the braking

The driving traction bar 72, 82, or 92 extending through the base of the caster 5 at the center of the rotation plane in the second through fourth wheel halting mechanisms 71, 81, and 91, and the pressure halt bar 104 or 116 in the fifth through seventh wheel halting mechanisms 101, 111, and 121 extends through the base of the caster 5 at the center of the rotation plane at the base of the caster 5. Therefore, even if the caster has a rotatable caster structure, regardless of the rotation direction, they do not become obstacle to the braking action on the wheel, ensuring the braking.

The pressure halt bar 84, 94, 104, or 116 in the third through sixth wheel halting mechanisms 81, 91, 101, and 111 arrests or presses on the outer surface of the wheel of the caster 5 to brake the wheel. Along with the fact that the driving traction bar 82 or 92 operating the pressure halt bar 84, 94, 104, or 116 or pressure halt bar 104 or 116 are provided at the center of rotation of the rotary caster 5, they are suitable for braking the wheel of a single-wheeled caster. The lower end of the pressure halt bar 84, 94, 104, or 116 is slightly pressed into the wheel for ensuring the braking.

Furthermore, the oscillating lever 73, 83, 93, or 103 in the second through fifth wheel halting mechanisms 71, 81, 91, and 101 properly doubles the traction force by means of leverage, enhancing the pressing or arresting action on the wheel of the caster 5.

In the sixth and seventh wheel halting mechanisms 111 and 121, the sliding surface 114 of the pressing member 113 moved back and forth by the slide cord 112 sliding back and forth causes the oscillated lever 115 to oscillate by the pressing action of the sliding surface 114. As the oscillated lever 115 oscillates, the pressure halt bar 116 moves down and arrests or presses on the wheel. In this way, the pulling force transmission mechanism 9 can have a transmission route to the wheel halting mechanism 111 or 121 in the lateral direction of the receptacle 1a of the baggage 1, providing more options in the entire structure.

The reference numbers referred to in the sections “Problem resolution means” and “Efficacy of the invention” are given for easy reference to the components shown in the drawings. The present invention is not confined to the structures/shapes presented by the reference numbers in the description and drawings.

### BRIEF DESCRIPTION OF THE DRAWINGS

FIG. 1 depicts a partially cutaway schematic front view of a baggage caster lock device according to the present invention;

FIG. 2A depicts a front view of a first embodiment of an operation mechanism operated by an extendable handle;

FIG. 2B depicts a side view of the operation mechanism shown in FIG. 2A;

FIG. 3A depicts a front view of a second embodiment of an operation mechanism;

FIG. 3B depicts a side view of the operation mechanism shown in FIG. 3A;

FIG. 4A depicts a front view of a third embodiment of an operation mechanism;

FIG. 4B depicts a side view of the operation mechanism shown in FIG. 4A;

FIG. 5A depicts a front view of a fourth embodiment of an operation mechanism;

FIG. 5B depicts a side view of the operation mechanism shown in FIG. 5A;

FIG. 6A depicts a front view of a fifth embodiment of an operation mechanism;

FIG. 6B depicts a side view of the operation mechanism shown in FIG. 6A;

FIG. 7A depicts a sectional front view of a first embodiment of a wheel halting mechanism;

FIG. 7B depicts a sectional side view of the wheel halting mechanism shown in FIG. 7A;

FIG. 8 depicts a sectional front view of a second embodiment of a wheel halting mechanism;

FIG. 9 depicts a sectional front view of a third embodiment of a wheel halting mechanism;

FIG. 10 depicts a sectional front view of a fourth embodiment of a wheel halting mechanism;

FIG. 11 depicts a sectional front view of a fifth embodiment of a wheel halting mechanism;

FIG. 12 depicts a sectional front view of a sixth embodiment of a wheel halting mechanism;

FIG. 13A depicts a sectional front view showing a seventh embodiment of a wheel halting mechanism;

FIG. 13B depicts a sectional side view of the wheel halting mechanism shown in FIG. 13A;

FIG. 14 depicts a cross-sectional view of a baggage caster lock device showing another embodiment in which the handle is housed in a handle housing to a level of a first housing depth and the caster is free to rotate; and

FIG. 15 depicts a cross-sectional view of a baggage caster lock device showing a state in which the handle is further pushed down in a handle housing to a level of a second housing depth and the wheel halting mechanism inhibits the rotation of the caster wheel.

### DETAILED DESCRIPTION OF THE PREFERRED EMBODIMENT

An embodiment for implementing the present invention will be described hereafter with reference to the drawings. A reference number 1 in the figures presents a piece of baggage such as a suitcase having a receptacle 1a for storing or holding a given volume of clothes and other things. With a given necessary capacity, a main part and a cover opening/closing with respect to the main part constitute a nearly rectangular body. A handle 2 comprising a pair of legs or a single center leg extendable in one or multiple steps is stored in the receptacle 1a at the back so that the handle 2 can be pulled out from the receptacle 1a for moving/walking A plurality of casters 5 for moving the baggage 1 itself are provided to the receptacle 1a at the four corners on the bottom surface and/or one side surface.

A caster lock device 10 is provided for temporarily halting an operation of the casters 5 in association with extension/retraction of the handle 2 as the handle 2 is retracted/stored. The caster lock device 10 is applicable to any type of caster 5 including a single caster having a roller or wheel of a single-wheel structure, a double caster having a pair of twin wheels structure, a fixed caster rotating in a fixed direction, and a rotary caster rotating in any direction.

The caster 5 is connected to the bottom of the receptacle 1a of the baggage 1 by providing a caster fitting portion 6 to which the caster 5 is fitted so as to move the baggage 1 in any direction. Of course, the caster 5 may be mounted on the bottom of the receptacle 1a to move the baggage 1 unidirectionally. A distal end of a transmission element 9 of a pulling force transmission mechanism is coupled to an actuating element of a wheel halting mechanism 61, which is described later, in a recess or compartment defined in the bottom space of the receptacle 1a in connection with the provision of the caster fitting portion 6.

The mounting of the caster 5 on the bottom of the receptacle 1a is achieved by the use of an inner cylindrical coupling element 7A and an outer cylindrical coupling element 7B. The inner cylindrical coupling element 7A has a cylindrical wall vertically extending through the bottom wall of the receptacle 1a and a flange at an upper end of the cylindrical wall thereof which engages with the upper surface of the bottom wall of the receptacle. The cylindrical wall of the inner cylindrical coupling element 7A is provided with an external thread on the outer peripheral surface thereof.

The outer cylindrical coupling element 7B has a cylindrical wall having a relatively larger diameter than that of the inner cylindrical coupling element 7A and vertically extending through a base panel 5a of the caster 5. The outer cylindrical coupling element 7B also has a flange at a lower end of the cylindrical wall thereof which engages with the lower surface of the base panel 5a of the caster 5. The cylindrical wall of the outer cylindrical coupling element 7B is provided with an internal thread on the inner peripheral surface thereof.

By screw-fitting the internal thread of the outer cylindrical coupling element 7B onto an external thread of the inner cylindrical coupling element 7A with a bearing device provided between the elements 7A and 7B, the base panel 5a of the caster 5, the bearing device and the bottom wall of the receptacle 1a are sandwiched between the flanges of the inner and outer cylindrical coupling element 7A and 7B. In this way, the caster 5 is mounted on the bottom of the receptacle 1a so as to be rotatable about a vertical axis. A through hole of the inner cylindrical coupling element 7A functions as a passage which provides a connection between the transmission element 9 of the pulling force transmission mechanism and the actuating part of the wheel halting mechanism 61.

The extendable handle 2 can be pulled or extended out of and retracted or housed in a cylindrical guide barrel 4 provided at the back of the receptacle 1a on the back board 3. When extended or housed, the handle 2 is properly locked in its state. A grip 212 of the handle 2 has shape of an inverted U, rectangular, or oblong frame bridging the upper ends of right and left legs. The illustrated handle 2 is of a twin bar type having a pair of legs 211 and guide barrels 4. A single bar type handle having a single leg and guide barrel 4 in one line can also be employed.

The caster lock device 10 comprises an operation mechanism 11 associated with extension/retraction of the handle 2 and operated as the handle 2 is retracted/stored, and a wheel halting mechanism 61 inhibiting the rotation of the wheel by mean of a halting force pressed against the outer or inner surface of the wheel of the caster 5 as the operation of the operation mechanism 11 is transmitted via the pulling force transmission mechanism 9 comprising a pulled wire and resiliently canceling the inhibition. The wire is housed in a protection tube of a small diameter to slide it therein smoothly. The wire is linked to the operation mechanism 11 and to the wheel halting mechanism 61 at its protruding portions protruding outside from each end of the protection tube by a given length, respectively.

The operation mechanism 11 is provided in close proximity to a grip housing space 201 formed at the top position of the receptacle 1a so that the operation mechanism 11 can operate as the handle 2 is stored/housed in the grip housing space 201.

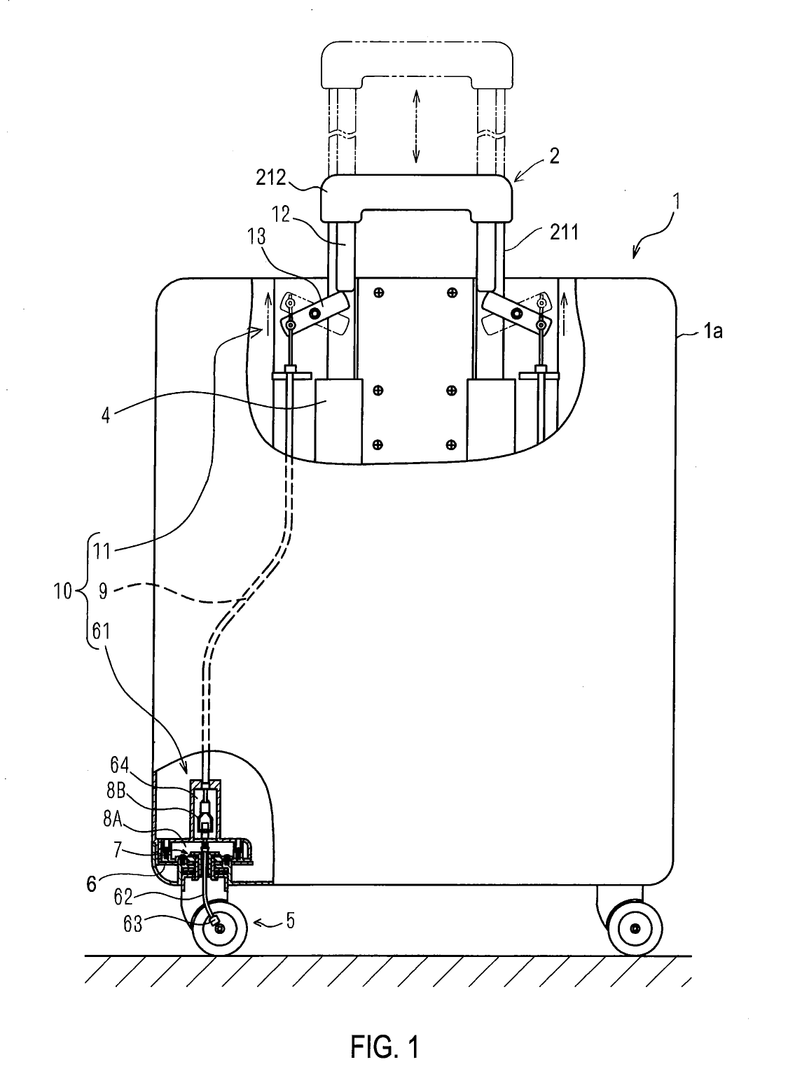

The first and second operation mechanisms 11 and 21 shown in FIGS. 1, 2, and 3 consist of an operation member 12 or 22 provided on any side of the upper part of the handle 2 and protruding from the surface of the handle 2, and an oscillating pull lever 13 or 23 oscillating as the operation member 12 or 22 moves down (downward motion) and to which the pulling force transmission mechanism 9 transmitting the oscillation to the wheel halting mechanism 61 is linked. The shown oscillating pull lever 13 or 23 is pivoted nearly at the center of the length thereof. When one end is oscillated downward by the operation member 12 or 22, the other end linked to the pulling force transmission mechanism 9 is oscillated upward to pull the pulling force transmission mechanism 9.

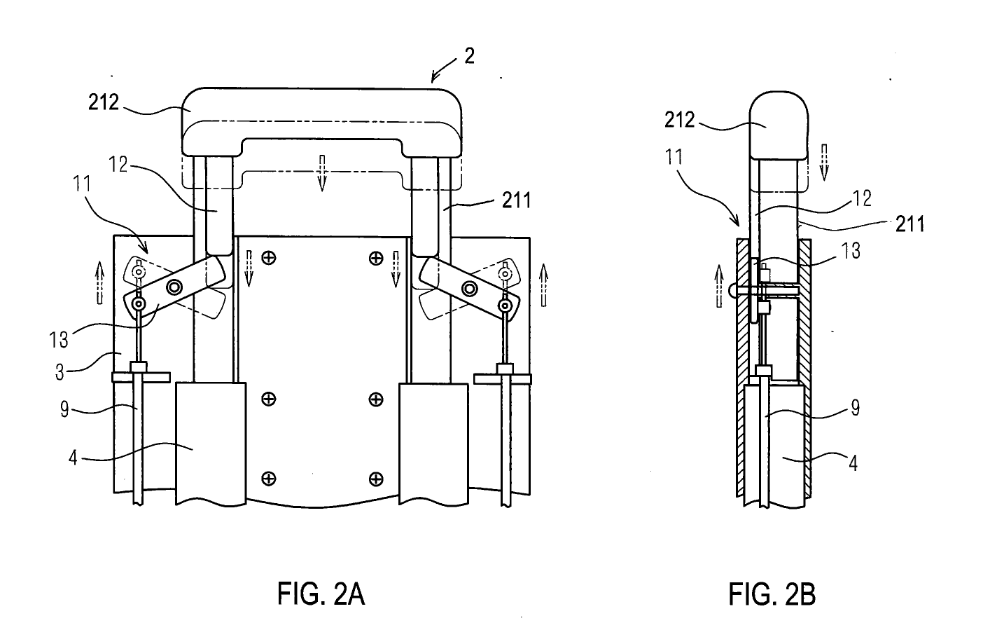

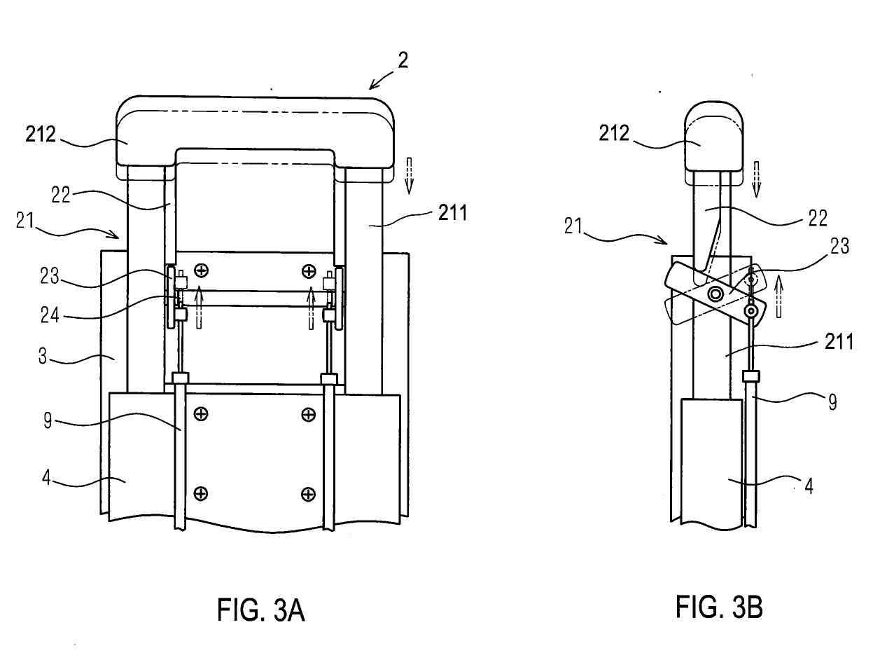

In the first operation mechanism 11 of FIGS. 1 and 2, the handle 2 has at least one leg 211 extending along the front face or back face of the receptacle 1a, said operation member 12 is extending downward from the grip 212 of said handle along the front face or back face of the leg 211. The oscillating pull lever 13 is pivotally supported at the center of the length thereof on the back board 3 so that it can oscillate. In the second operation mechanism 21 of FIG. 3, the operation member 22 is provided either on the right side or on the left side of a leg 211, namely on the inner side of a twin bar type legs 211. The oscillating pull lever 23 is pivotally supported at the center of the length thereof on the back board 3 by a pivot 24 so that it can oscillate. The operation member 22 of the second operation mechanism 21 has a lower end having an inclined surface so that the oscillating pull lever 23 can tilt in a wider range.

In the first operation mechanism 11, the operation member 12 and oscillating pull lever 13 are provided on the front or back face of the legs 211 so that they can compactly be provided on the side of the receptacle 1a.

The third and fourth operation mechanisms 31 and 41 consist of an operation member 32 or 42 provided on any side of the grip 212 of the handle 2 and protruding downward from the lower surface of the grip 212, a vertically movable slide bar 33 or 43 moving down when pushed by the operation member 32 or 42 (downward motion) moving down and to which the pulling force transmission mechanism 9 transmitting the downward motion to the wheel halting mechanism 61 is linked, and a guide 34 or 44 for guiding the slide bar 33 or 43 in the vertical direction. Furthermore, in consideration of the flexibility of the wire of the pulling force transmission mechanism 9, the wire linked to the right slide bar 33 or 43 goes to the left and the wire linked to the left slide bar 33 or 43 goes to the right, although this crossing structure is arbitrary.

The guide 34 or 44 is, for example, in the form of a flat groove in section. The slide bar 33 or 43 is in the form of a slightly wide band plate and smoothly slides along the guide 34 or 44 in the vertical direction. The wire of the pulling force transmission mechanism 9 is positioned at the opening of the slide guide 34 or 44 and linked to the slide bar 33 or 43. Here, the slide bar 33 or 43 is stopped by a proper stopper at a given position so that it does not disengage/come off from the guide 34 or 44 as the handle 2 is pulled out and extended and the slide bar 33 or 34 moves up (upward motion) along the guide 34 or 44.

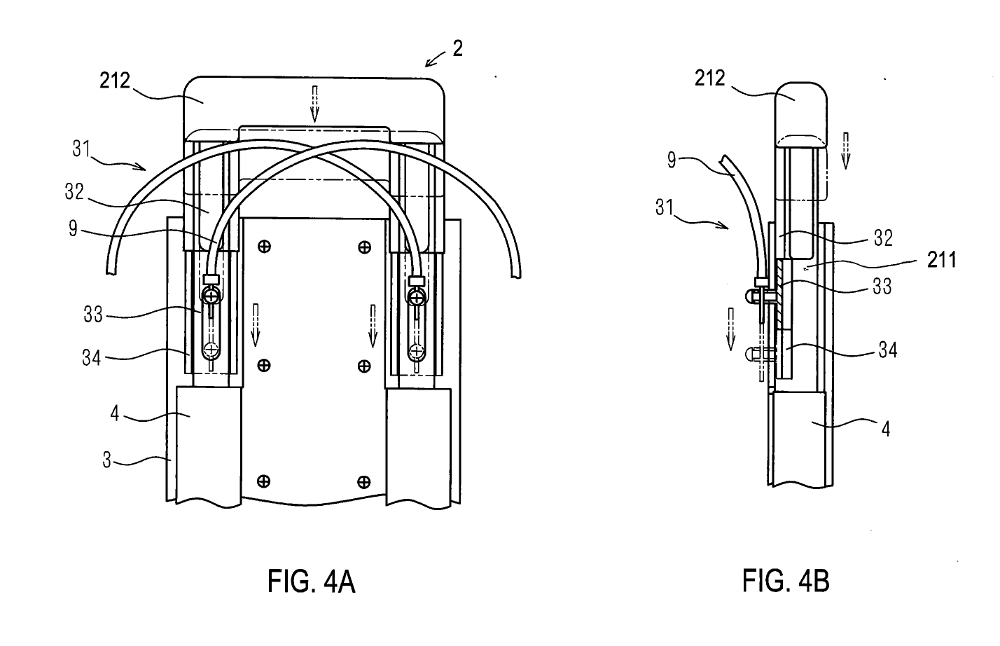

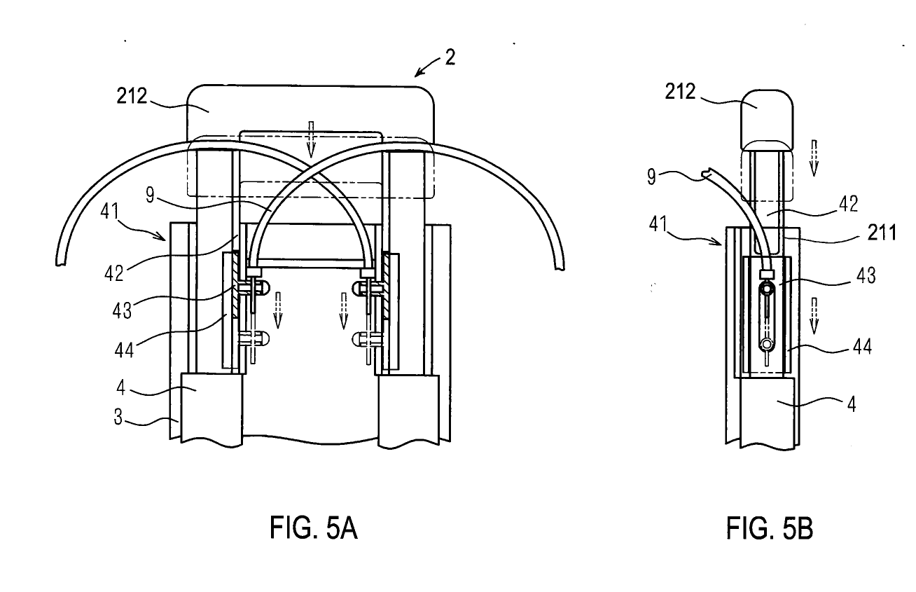

In the third operation mechanism 31 of FIG. 4, the operation member 32 and vertically movable slide bar 33 are provided on the front or back face of a leg 211 in the upper part of the handle 2 and the slide guide 34 is fixed to the above-described back board 3 or to the outer wall of the receptacle 1a. In the fourth operation mechanism 41 of FIG. 5, the operation member 42 and vertically movable traction bar 43 are provided on the inner side of a leg 212 in the upper part of the handle 2 and the vertical slide guide 44 is fixed to the back board 3 or to the outer wall of the receptacle 1a.

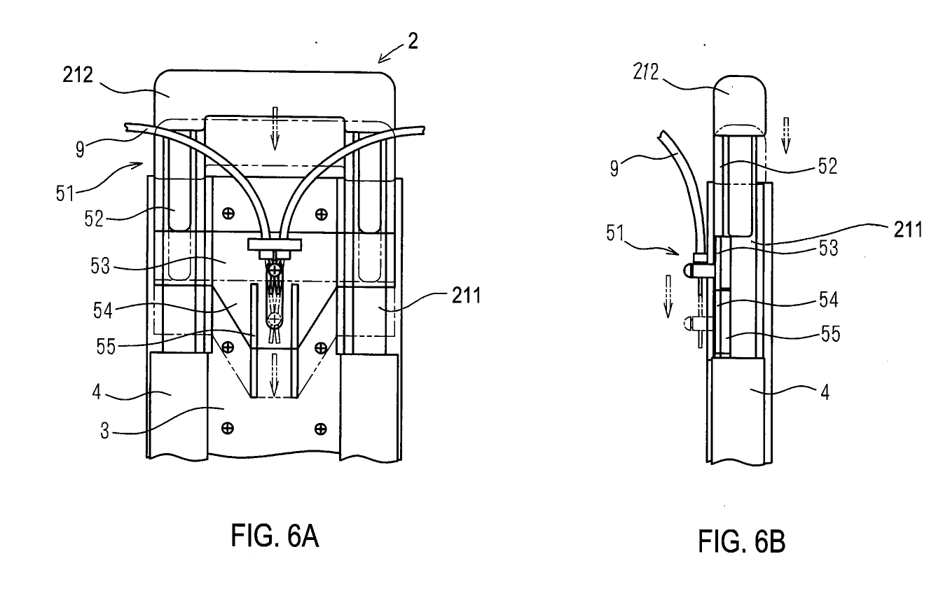

The fifth operation mechanism 51 shown in FIG. 6 consists of an operation member 52 provided either on the front face or on the back face of the upper part of the handle 2 and protruding from the surface of the handle 2, a vertically movable traction board 53 extending between the right and left legs of the handle 2 and to which the pulling force transmission mechanism 9 transmitting to the wheel halting mechanism 61 is linked, and a vertical slide guide 55 guiding the vertically movable traction board 53 in the vertical direction. The vertically movable traction board 53 has a nearly mountain-like guiding protrusion 54 protruding downward at the center. The guiding protrusion 54 is fitted, for example, in a pair of vertical slide guides 55 provided on the above-described back board 3 or on the outer wall of the receptacle 1a in a vertically movable manner so that the vertically movable traction board 53 smoothly slides in the vertical direction. A pair of the wires of the pulling force transmission mechanism 9 is screwed, for example, to the guiding protrusion 54. The wires are pulled as the operation member 52 moves down and pushed back as the operation member 52 moves up.

The wheel halting mechanism 61 will be described hereafter. The wheel halting mechanism 61 halts or brakes the wheel of a caster 5 by means of a pressing force on the inner or outer surface thereof when the caster 5 has a double-caster structure and by means of a pressing force on the outer surface thereof when the caster 5 has a single-caster structure.

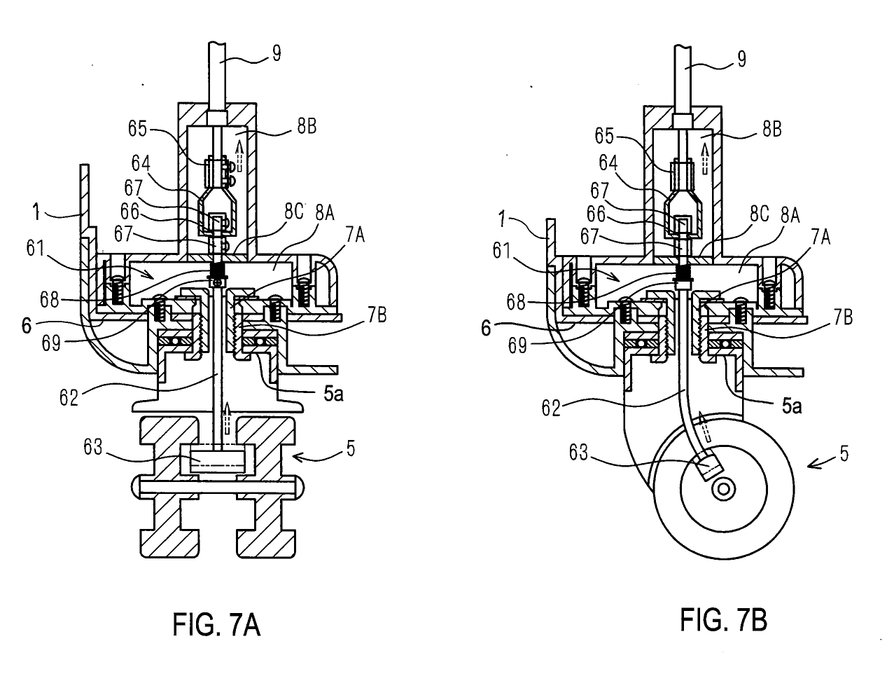

The first wheel halting mechanism 61 shown in FIG. 7 presses on the inner surface of the wheel of a caster 5 having a double-caster structure, comprising a flexible traction cord 62 extending through the base of the caster 5, namely the above-described mounting support A and coupling support 7B at the center of the rotation plane at the base of the caster 5 placed at the above-described mounting part 6 and linked to an end of the pulling force transmission mechanism 9, a brake pad 63 fixed to an end of the traction cord 62 and pressing on the inner surface of the wheel as a result of traction of the traction cord 62, a linking member 64 linking the traction cord 62 to the pulling force transmission mechanism 9, and a restoring part 68 resiliently biasing the traction cord 62 to move the brake pad 63 away from the inner surface of the wheel.

The traction cord 62 consists of, for example, a wire of a given diameter. Extending through the mounting support 7A, the traction cord 62 has an upper end coupled to the wire of the pulling force transmission mechanism 9 by the linking member 64 and a lower end coupled to the brake pad 63 facing the inner periphery of the outer edge protrusion of the wheel between the right and left wheels in a twin-wheel structure. The brake pad 63 is made of, for example, a synthetic resin or rubber material having a high friction coefficient. As the traction cord 62 is pulled, the brake pad 63 presses on the inner surface of the outer edge protrusion of the wheel to halt the wheel.

The linking member 64 is provided in a linking chamber 8B formed within the receptacle la above an installation chamber 8A and has a wire coupling part 65 at the top and a cord coupling part 66 at the bottom. Then, the wire coupling part 65 is used to clamp and screw the end of the wire. The cord coupling part 66 is used to securely screw (67) the upper end part of the traction cord 62 rotatably inserted therein at points inside and outside the inserted part of the traction cord 62. In other words, in the cord coupling part 66, the upper end part of the traction cord 62 inserted through the wall of the cord coupling part 66 is screwed on the inner and outer wall surfaces of the cord coupling member 66 itself by lock tools 67 so that the linking member 64 and traction cord 62 can relatively rotate while they stay in the inserted/coupled state. Here, it is possible that the linking member 64 has, for example, a not-shown cylindrical form into which male screws are screwed at the top and bottom, and the lower end of the wire of the pulling force transmission mechanism 9 and the upper end of the traction cord 62, which are inserted therein, are fastened by means of the ends of the male screws for linking

The restoring part 68 consists of a coil spring compressed and biased for expansion between a partition 8C positioned at the above-described mounting part 6 and separating the installation chamber 8A and linking chamber 8B formed at the bottom of the receptacle 1a, and a spring block 69 secured to the lower part of the traction cord 62 within the installation chamber 8A. The coil spring is compressed and builds up resilience when the brake pad 63 is pulled by the above-described operation mechanism 11 . . . via the pulling force transmission mechanism 9 and traction cord 62 to press on the inner surface of the wheel, and expands to move the brake pad 63 away from the wheel inner surface when the pressing force on the brake pad 63 is canceled by the operation mechanism 11.

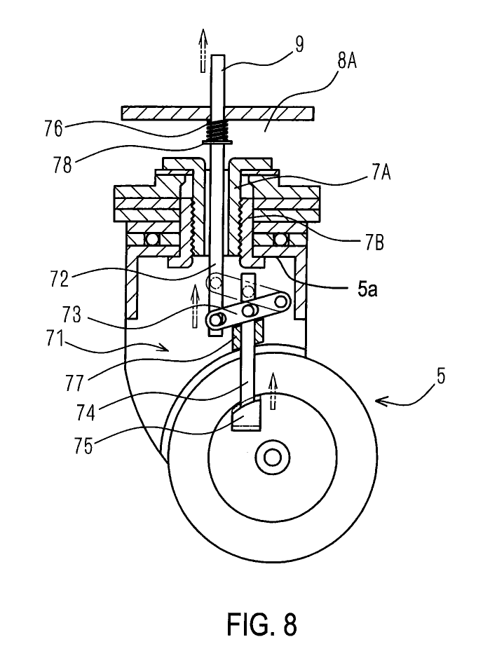

The second wheel halting mechanism 71 shown in FIG. 8 comprises an operation transmission structure making a lever motion for pressing on the inner surface of the wheel of a caster 5 having a double-caster structure. In other words, the second wheel halting mechanism 71 comprises a driving traction bar 72 extending through the base of the caster 5, namely the above-described mounting support 7A and coupling support 7B at the center of the rotation plane at the base of the caster 5 placed at the above-described mounting part 6 and linked to an end of the pulling force transmission mechanism 9, an oscillating lever 73 rotatably supported within the caster 5, for example, at its fork part and at an end of which the driving traction bar 72 is pivotally supported, a driven traction bar 74 pivotally supported by the oscillating lever 73 in a vertically movable manner and moving up and down in the same direction as the driving traction bar 72 as the oscillating lever 73 oscillates, a brake pad 75 coupled to the lower end of the driven traction bar 74 and pressing on the inner surface of the wheel of the caster 5, and a restoring part resiliently biasing the driving traction bar 72 to move the brake pad 75 away from the inner surface of the wheel.

The parts of the oscillating lever 73 that link and pivotally support the driving traction bar 72 and driven traction bar 74 each consist of an elongated hole for smooth oscillation. The driven traction bar 74 is extended, for example, through a vertical motion guide 77 provided to the caster 5 itself for smoothly guiding the driven traction bar 74 in vertical motion.

The driving traction bar 72 protrudes from the installation chamber 8A and is linked to the wire of the pulling force transmission mechanism 9 outside the installation chamber 8A via, for example, the above-described linking member 64. The restoring part 76 consists of a coil spring compressed and resiliently biased for expansion between the upper wall of the installation chamber 8A and a spring block 78 securely screwed to the upper part of the driving traction bar 72 within the installation chamber 8A.

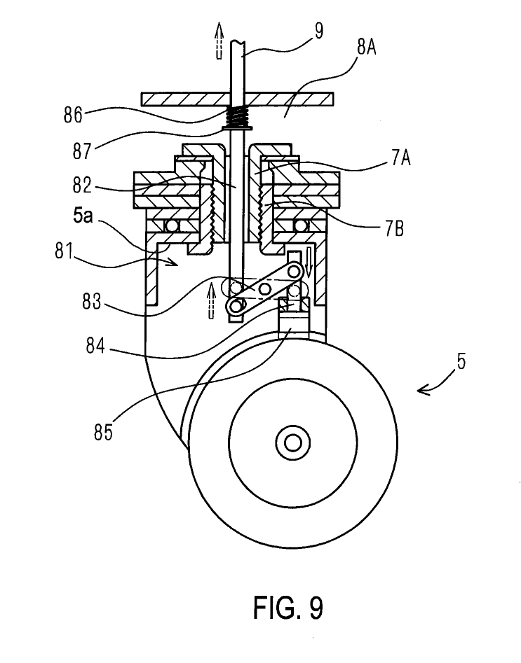

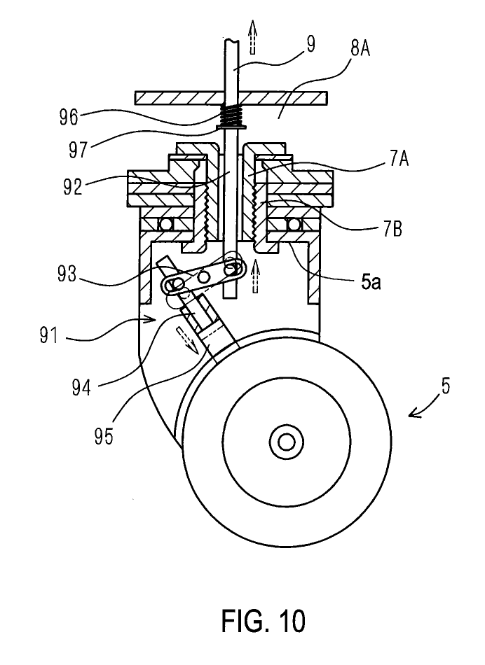

The third and fourth wheel halting mechanisms 81 and 91 shown in FIGS. 9 and 10 press on the outer surface of the wheel of a caster 5 having a single-caster structure, comprising a driving traction bar 82 or 92 extending through the base of the caster 5, namely the above-described mounting support 7A and coupling support 7B at the center of the rotation plane at the base of the caster 5 placed at the above-described mounting part 6 and linked to an end of the pulling force transmission mechanism 9, an oscillating lever 83 or 93 rotatably supported within the caster 5, for example at its fork part, and at an end of which the driving traction bar 82 or 92 is pivotally supported, a pressure halt bar 84 or 94 pivotally supported by the oscillating lever 83 or 93 in a vertically movable manner and moving up and down in the opposite direction to the driving traction bar 82 or 92 as the oscillating lever 83 or 93 oscillates, a brake pad 85 or 95 coupled to the lower end of the pressure halt bar 84 or 94 and pressing on the outer surface of the wheel of the caster 5, and a restoring part 86 or 96 resiliently biasing the driving traction bar 82 or 92 to move the brake pad 85 or 94 away from the outer surface of the wheel.

Here, the brake pad 85 of the third wheel halting mechanism 81 is provided nearly directly above the wheel, and the brake pad 95 of the fourth wheel halting mechanism 91 is provided slightly diagonally above the wheel; they have nearly the same basic structure.

Furthermore, the upper end of the driving traction bar 82 or 92 is linked to the wire of the pulling force transmission mechanism 9 via the linking member 64 of the above-described first wheel halting mechanism 61, taking into account prevention of twist due to rotation of the caster 5.

The oscillating lever 83 or 93 is rotatably supported by the caster 5 nearly at the center, at one end of which the driving traction bar 82 or 92 is pivotally supported and at the other of which the pressure halt bar 84 or 94 is pivotally supported. Ascent (upward motion) of the driving traction bar 82 or 92 is converted to decent (downward motion) of the pressure halt bar 84 or 94 to cause the brake pad 85 or 96 to press on the wheel. For increasing the pressing force, the oscillating lever 83 or 93 will rotationally be supported at a point closer to the driving traction bar 82 or 92.

Here, the restoring part 86 or 96 consists of a coil spring compressed and resiliently biased for expansion between the upper wall of the installation chamber 8A and a spring block 87 or 97 securely screwed to the upper part of the driving traction bar 82 or 92 within the installation chamber 8A.

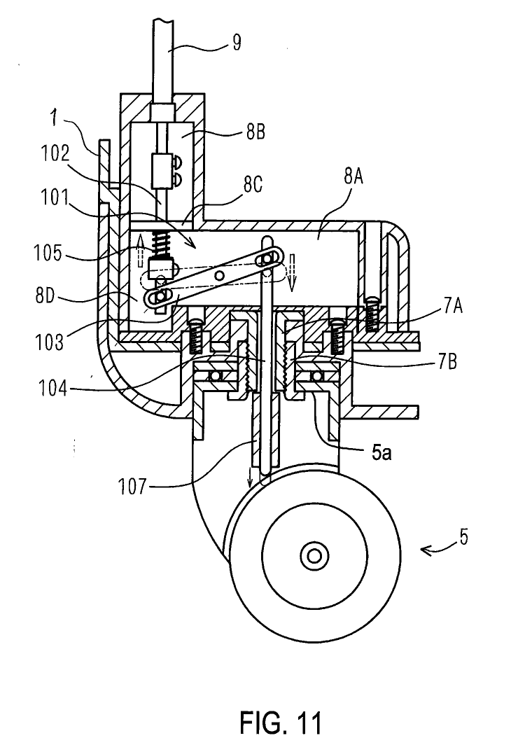

In the fifth wheel halting mechanism 101 shown in FIG. 11, an oscillating lever is provided in the installation chamber 8A while the oscillating lever 73, 83, or 93 is provided to the caster 5 in the second through fourth wheel halting mechanisms 71, 81, and 91. This provision within the receptacle 1a prevents external obstacles to the lever motion such as dirt and impact. In other words, the fifth wheel halting mechanism 101 comprises a driving traction bar 102 vertically movable within an operation chamber 8D formed within the receptacle 1a at a side above the above-described mounting part 6 where the caster 5 is mounted and linked to an end of the pulling force transmission mechanism 9, an oscillating lever 103 rotatably supported within the installation chamber 8A and at an end of which the driving traction bar 102 is pivotally supported, an pressure halt bar 104 pivotally supported by the oscillating lever 103 in a vertically movable manner, extending through the base of the caster 5, namely the above-described mounting support 7A and coupling support 7B at the center of the rotation plane at the base of the caster 5 placed at the above-described mounting part 6 so as to move up and down in the opposite direction to the driving traction bar 102 as the oscillating lever 103 oscillates, and having a lower end pressing on the outer surface of the wheel of the caster 5, and a restoring part 105 resiliently biasing the driving traction bar 102 to move the pressure halt bar 104 away from the outer surface of the wheel. Here, the fifth wheel halting mechanism 101 is suitable for arresting the outer surface of the wheel of a caster 5 having a single-caster structure.

The operation chamber 8D of the fifth wheel halting mechanism 101 is formed laterally next to the above-described installation chamber 8A separately or as an integrated compartment, and has a partition 8E separating the upper and lower parts. When the operation chamber 8D is continued from the installation chamber 8A to form an integrated compartment as shown, the oscillating lever 103 is positioned closer to the operation chamber 8D and pivotally supported within the installation chamber 8A. When the operation chamber 8D is formed separately from the installation chamber 8A, the oscillating lever 103 is positioned and pivotally supported within the installation chamber 8A, which is not shown.

The oscillating lever 103 is rotatably supported nearly at the center within the installation chamber 8A, at one end of which the driving traction bar 102 is pivotally supported and at the other end of which the pressure halt bar 104 is pivotally supported. Ascent (upward motion) of the driving traction bar 102 is converted to decent (downward motion) of the pressure halt bar 104 to cause the lower end of the pressure halt bar 104 to press on the wheel. For increasing the pressing force, the oscillating lever 103 will rotationally be supported at a point closer to the driving traction bar 102.

Here, the driving traction bar 102 is linked to the wire of the pulling force transmission mechanism 9 in the upper part of the operation chamber 8D. The restoring part 105 consists of a coil spring compressed and resiliently biased for expansion between the underside of the partition wall 8C of the operation chamber 8D and a spring block 106 securely screwed to the upper part of the driving traction bar 102 in the lower part of the operation chamber 8D. Furthermore, the pressure halt bar 104 is extended, for example, through a vertical motion guide 107 provided to the caster 5 itself for smoothly guiding the pressure halt bar 104 in vertical motion.

A not-shown brake pad pressing on the outer surface of the wheel of the caster 5 can be coupled to the lower end of the pressure halt bar 104 for further ensuring the pressure halt action.

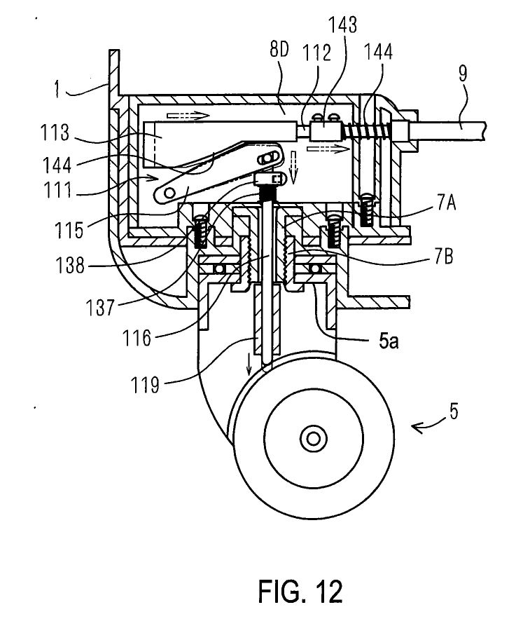

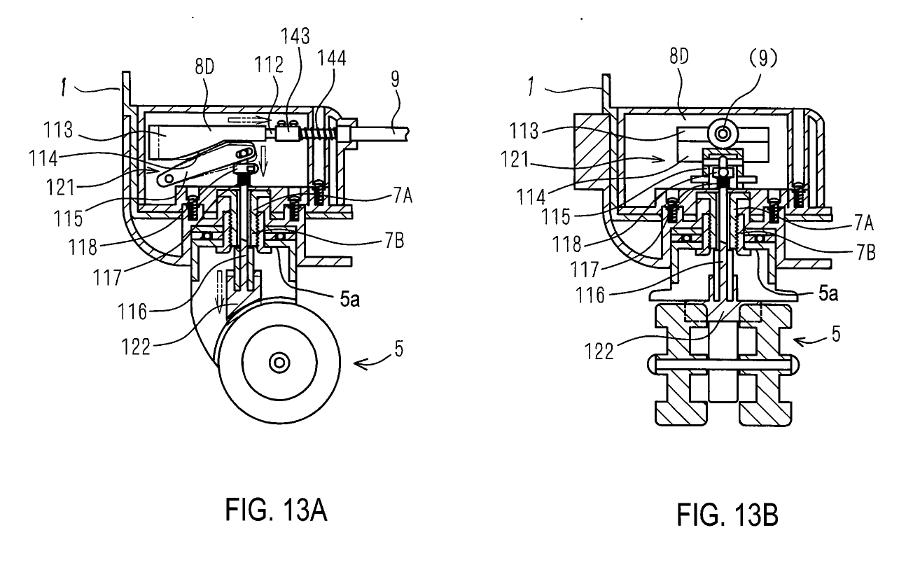

The sixth and seventh wheel halting mechanisms 111 and 121 shown in FIGS. 12 and 13 have a horizontal structure moving back and forth (right and left) while the traction cord 62 or driving traction bar 72, 82, 92, or 102 is provided nearly in the vertical direction above the caster 5 and move vertically in the first through fifth wheel halting mechanism 61 and 101.

In other words, the sixth wheel halting mechanism 111 comprises a slide cord 112 coupled to the pulling force transmission mechanism 9 so as to slide back and forth within the above-described installation chamber 8A, a pressing member 113 coupled to the slide cord 112 and having a bottom surface gradually inclined downward toward the rear end of the slide cord 112 to form a sliding surface 114, an oscillated lever 115 oscillating downward as the sliding surface 114 of the pressing member 113 slides forward, a pressure halt bar 116 extending through the base of the caster 5, namely the above-described mounting support 7A and coupling support 7B at the center of the rotation plane at the base of the caster 5 placed at the above-described mounting part 6 and having a lower end pressing on the outer surface of the wheel of the caster 5, and a restoring part 117 resiliently biasing the pressure halt bar 116 to move the pressure halt bar 116 away from the outer surface of the wheel. Here, the sixth wheel halting mechanism 111 is suitable for arresting the outer surface of the wheel of a caster 5 having a single-caster structure.

The pressing member 113 is installed slidably in the back and forth direction within the installation chamber 8A. The pressing member 113 is pulled toward the pulling force transmission mechanism 9 in front against the resilience of a restoring spring 144 in the form of an expandable coil spring compressed between a linking member 143 linking the slide cord 112 extending through the front wall of the installation chamber 8A and the wire of the pulling force transmission mechanism 9 and the front wall of the installation chamber 8A. The sliding surface 114 at the underside of the pressing member 113 faces the upper surface of the oscillated lever 115. The oscillated lever 115 is pivotally supported at its rear part near the rear end of the sliding surface 114. The front part of the oscillated lever 115 is pivotally supported by the upper part of the pressure halt bar 116. In this way, the pressing member 113 moving forward pushes down the oscillated lever 115 and causes it to oscillate. The downward oscillation of the oscillated lever 115 results in pushing down the pressure halt bar 116 and arresting the wheel of the caster 5.

The restoring part 117 consists of a coil spring compressed and resiliently biased for expansion between the upper surface of the above-described mounting support 7A and a spring block 118 securely screwed to the upper part of the pressure halt bar 116 within the installation chamber 8A. Furthermore, the pressure halt bar 116 is extended, for example, through a vertical motion guide 119 provided to the caster 5 itself for smoothly guiding the pressure halt bar 116 in vertical motion.

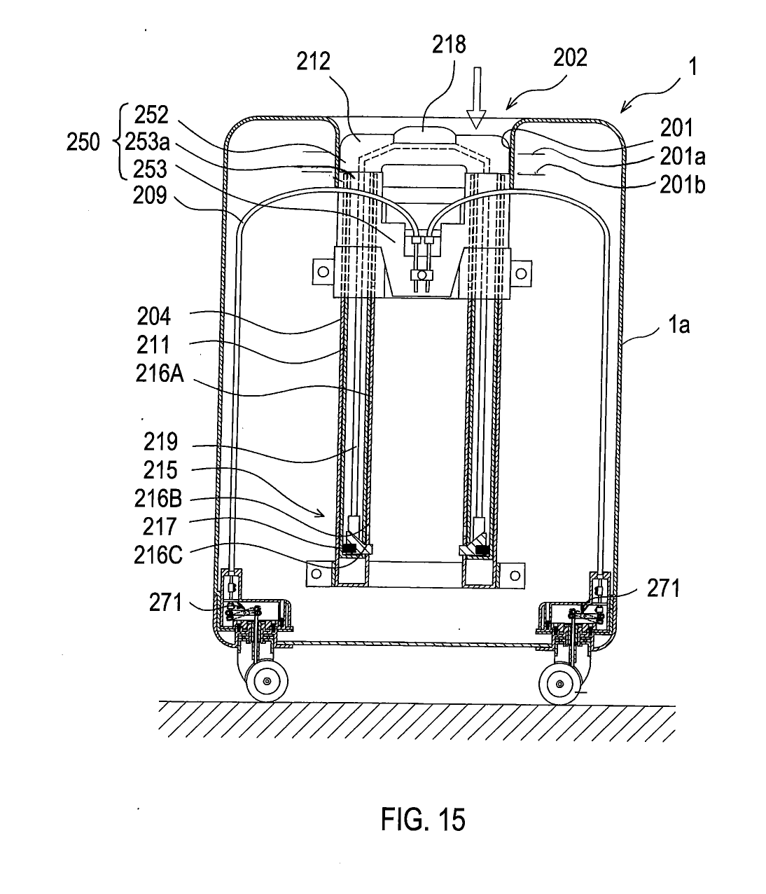

The difference between the seventh wheel halting mechanism 121 shown in FIG. 15 and the sixth wheel halting mechanism 111 is that the former has a pressing structure for wheels that are twin wheels of a cater 5 having a double-caster structure while the latter has an arresting structure for a wheel that is a single wheel of a caster 5 having a single-caster structure. The common structures are referred to by the same reference numbers and their explanation is omitted. More specifically, a brake pad 122 having a width extending across a pair of wheels is coupled to the lower end of the pressure halt bar 116 so as to press on across the outer surfaces of the wheels of a double-caster structure.

In the seventh wheel halting mechanism 121, the above-described oscillated lever 115 has nearly an inverted U shape in section, ensuring that the rotatably supported oscillated lever 115 and pivotally supported pressure halt lever 116 operate in a stable manner without tilting right or left. However, needless to say, the oscillated lever 115 having nearly an inverted U shape in section is also applicable to the sixth wheel halting mechanism 111.

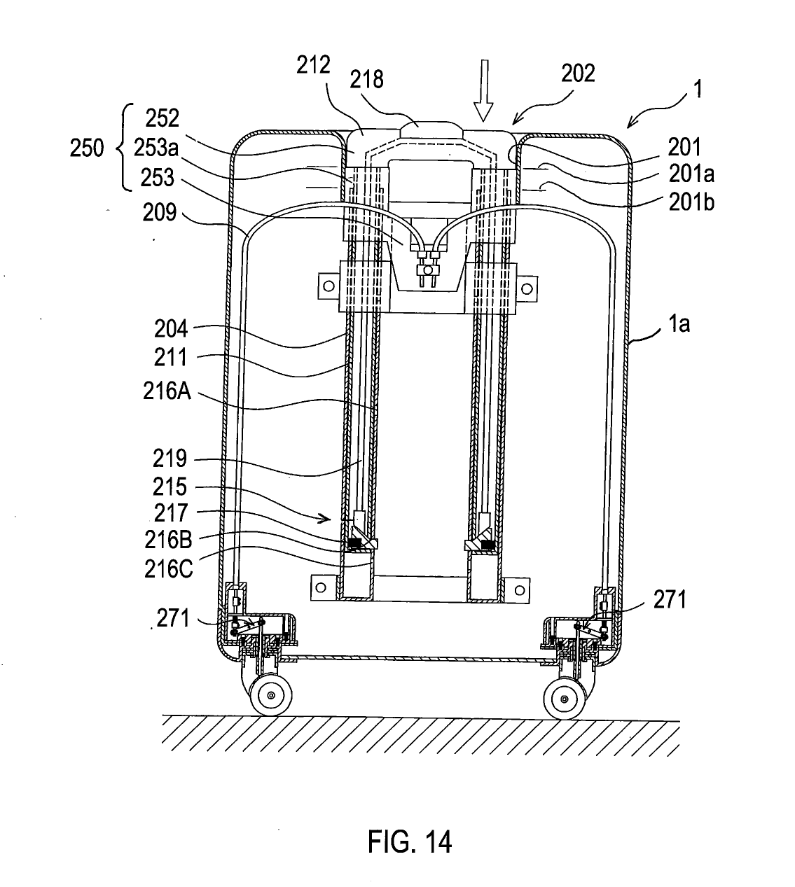

FIGS. 14 and 15 show another embodiment. In this embodiment, the grip housing space 201 in the receptacle 1a of the baggage 1 has multiple housing depths 201a and 201b for the grip 212. An operation mechanism 250 of this embodiment consists of an operation member 252 moving down together with the grip 212 and a traction board 253 with which the lower end of the operation member 252 makes contact. The traction board 253 comprises a slider part 253a for sliding the traction board 253 along the guide barrel 4 at each of the right and left sides. The traction board 253 moves vertically between a position where the upper end of the slider part 253a is nearly flush with the first housing depth 201a in the grip housing space 201 and a position where it is nearly flush with the second housing depth 201b. Therefore, when the grip 212 is housed to the first housing depth 201a, the operation member 252 does not push down the traction board 253. Consequently, in this state, the traction board 253 does not pull the pulling force transmission mechanism member or cause a wheel halting mechanism 271 to operate. Then, when the grip 212 is further pushed down to the second housing depth 201b that is deeper than the first housing depth 201a, the operation member 252 pushes down the traction board 253 and a transmission element 209 pulled by the traction board 253 causes the wheel halting mechanism 271 to operate. Therefore, in this embodiment, the wheel halting mechanism 271 does not operate when the grip 212 is housed only to the first housing depth 201a.

As shown in FIGS. 14 and 15, the handle 2 is hollow and has legs 211 each slidably inserted in a cylindrical guide barrel 4 on the back of the receptacle 1a of the baggage 1. The legs 211 can be extended above the receptacle 1a and pushed in/housed within the receptacle 1a from above. Furthermore, the handle 2 comprises a lock mechanism 215 to temporarily keep the legs 211 immovable with respect to the guide barrel 4 at multiple proper positions as the legs 211 slide along the guide barrel 4.

The lock mechanism 215 consists of multiple lock holes 216A, 216B, and 216C formed on the guide barrel 204 at given positions, a click member 217 attached to the lower end of the leg 211 of the handle 2 in an oscillating manner to resiliently lock in the holes, a release button 218 provided on the grip 212 of the handle 2, and a transmission means 219 provided between the click member 217 and release button 218. As the release button 218 is pressed down, the click member 217 oscillates via the transmission means 219 to release the lock from any of the holes 216A, 216B, and 216C. Consequently, the legs 211 of the handle 2 are free to slide. As the click member 217 locks in any of the holes 216A, 216B, and 216C, the movement of the handle 2 along the guide barrel 4 is seized and the release button 218 is returned to the initial position from the pressed-down state.

The lock hole 216A of the guide barrel 4 is a hole the click member 217 locks in when the grip 212 is pulled out from the grip housing space 201 of the baggage 1 for use, and is provided at multiple, two in the illustrated case, positions so that the handle 2 is pulled out to a selected length. The lock hole 216B is a hole 216B the click member 217 locks in when the grip 212 is housed in the grip housing space 201 to the first housing depth 201a as shown in FIG. 14; then, the upper edge of the grip 212 of the handle 2 is nearly flush with the upper edge of the receptacle 1a. In this state, the traction board 253 of the operation mechanism is not pushed down and, therefore, the transmission element of the pulling force transmission mechanism is not pulled and the wheel halting mechanism does not operate. The lock hole 216C is a hole the click member 217 locks in when the handle 2 is stored to the second housing depth 201b as shown in FIG. 15. When the handle 2 is pushed down to the second housing depth 201b as in this case, the operation member 252 on the grip 212 of the handle 2 abuts the above-described slide part 204a provided on the either side of the traction board 253 and pushes down the traction board 253. Consequently, the pulled transmission element causes the wheel halting mechanism to operate, maintaining the caster 5 in the locked state. The handle 2 cannot be further pushed in from the second housing depth 201b.

On the other hand, as the release button 218 is pressed down to unlock the handle 2 and the grip 212 is pulled up from the second housing depth 201b of the grip housing space 201, the restoring part of the wheel halting mechanism raises the traction board 253 together with the handle 2 and relaxes the transmission element 209 of the pulling force transmission mechanism, unlocking the caster 5.

The lock mechanism 215 having the above structure and efficacy allows the handle 2 to be directly pulled out from the caster-locked position or pushed in from the handle pullout position where the baggage 1 is allowed to move to the second housing depth 201b where the caster 5 is locked without temporarily stopping at the first housing depth 201a.

Here, as to the caster lock device according to the embodiment of FIGS. 14 and 15, any operation mechanism 11 shown in FIGS. 1 to 6, any pulling force transmission mechanism 9, and any wheel halting mechanism 61 shown in FIGS. 7 to 13 are applicable. For example, the operation mechanism may comprise right and left oscillating levers as shown in FIG. 3 which tilt when the grip 212 of the handle 2 is further pushed down from the first housing depth to the second housing depth 201b, and a central traction board as shown in FIG. 6 which moves vertically by means of the tilting movement of the oscillating levers of FIG. 3, wherein the pulling force transmission mechanism 9 is linked to the central traction board.

1. A caster lock device for baggage provided with a receptacle, an extendable handle that can be pulled out of or housed in the receptacle by a user, and casters provided on the bottom of the receptacle for making said receptacle easily movable, comprising:
an operation mechanism associated with an operation to pull or house said handle out of or in said receptacle;
a pulling force transmission mechanism having a transmission element that is pulled by means of said operation mechanism as said handle is operated to be housed; and
a wheel halting mechanism for converting a pulling force that is transmitted by said pulling force transmission mechanism to a pressing force applied to at least one wheel of said casters to bring said wheel to a halt,
wherein said wheel halting mechanism includes a restoring means exerting resilience to restore said transmission element to the original position as said handle is operated to pull out of said receptacle so as to cancel the pressing force applied to said wheel of said caster.

2. The baggage caster lock device according to claim 1, wherein said handle has a grip, said operation mechanism including an operation member protruding downward from the grip of said handle and an oscillating pull lever tilting upon contact with said operation member which moved down together with said handle as the handle is housed,
wherein said transmission element of said pulling force pulling force transmission mechanism transmits the tilt of said pull lever to said wheel halting mechanism, said transmission element being linked to said oscillating pull lever,
wherein said oscillating pull lever is pivoted nearly at the center thereof and having one end abutting on the lower end of said operation member and the other end linked to said transmission element so that when said one end of said oscillating pull lever is tilted downward by means of said operation member, the other end is tilted upward to pull said transmission element.

3. The baggage caster lock device according to claim 2, wherein said handle has at least one leg extending along the front face or back face of said receptacle, said operation member extending downward from the grip of said handle along the front face or back face of said leg.

4. The baggage caster lock device according to claim 2, wherein said handle has at least one leg extending along the front or back face of said receptacle, said operation member extending downward from the grip of said handle along the right side or left side of said leg.

5. The baggage caster lock device according to claim 1, wherein said handle has a grip, said operation mechanism including an operation member protruding downward from the grip of said handle; a slide bar moving down when the slide bar is pushed down by said operation member which moved down together with said handle as the handle is housed; and a slide guide for guiding said slide bar in the vertical direction,
wherein said transmission element of said pulling force pulling force transmission mechanism transmits the downward motion of said slide bar to said wheel halting mechanism, said transmission element being linked to said slide bar,
wherein said slide bar pulls said transmission element as the slide bar is pushed down by means of said operation member, and
wherein said slide guide is fixed to said receptacle.

6. The baggage caster lock device according to claim 5, wherein said handle has at least one leg extending along the front face or back face of said receptacle, said operation member extending downward from said grip of said handle along the front face or back face of said leg, and said slide bar being disposed beneath said operation member along the front face or back face of said leg.

7. The baggage caster lock device according to claim 5, wherein said handle has at least one leg means extending along the front face or back face of said receptacle, said operation member extending downward from said grip of said handle along the right side or left side of said leg, and said slide bar being disposed beneath said operation member along the right side or left side of said leg.

8. The baggage caster lock device according to claim 1, wherein said handle has a grip and a pair of legs downwardly extending from said grip along the front face or back face of said receptacle,
wherein said operation mechanism includes an operation member protruding downward from said grip of said handle, a traction board extending across said pair of legs and moving down when the traction board is pushed down by means of said operation member which moved down together with said handle as the handle is housed, and a slide guide guiding the traction board in the vertical direction,
wherein said transmission element of said pulling force pulling force transmission mechanism transmits the downward motion of said traction board to said wheel halting mechanism, said transmission element is linked to said traction board, and
wherein said slide guide is firmly supported by said receptacle.

9. The baggage caster lock device according to claim 8, wherein said receptacle includes a grip storage space, and
wherein as said grip of handle is housed in said grip storage space, said traction board is pushed down by mean of said operation member to pull said transmission element and cause said wheel halting mechanism to operate.

10. The baggage caster lock device according to claim 9, wherein said grip storage space has a first storaging depth and a second storaging depth deeper than the first storaging depth,
wherein the transmission element of said pulling force transmission mechanism does not cause said wheel halting mechanism to operate when said grip of handle is housed in said grip storage space at the level of said first storaging depth, the transmission element of said pulling force transmission mechanism causing said wheel halting mechanism to operate when said grip is pushed down to the level of said second storaging depth.

11. The baggage caster lock device according to claim 8, wherein said traction board has a protrusion protruding downward in the center part thereof, said protrusion sliding along a slide guide which is firmly supported by said receptacle.

12. The baggage caster lock device according to claim 1, wherein said wheel halting mechanism comprises:
a flexible traction cord vertically extending into a chamber formed in said receptacle through a base panel of said caster, the flexible traction cord being coupled to a distal end of said transmission element so that the driving traction bar can vertically move in unison with the movement of said transmission element;
a brake pad fixed to a lower end of said traction cord for being pressed against the inner surface of said wheel when said traction cord is pulled by means of said transmission element;
a coupling device disposed in said chamber of said receptacle for coupling said traction cord to said distal end of said transmission element; and
a restoring means resiliently biasing said traction cord to move said brake pad away from the inner surface of said wheel.

13. The baggage caster lock device according to claim 12, wherein said coupling device has a wire coupling in the upper part and a cord coupling in the lower part, said wire coupling being used to clamp said distal end of said transmission element, and said cord coupling being used to clamp the upper end of said traction cord while allowing said traction cord to be free to rotate about an axis of said traction cord with respect to said cord coupling.

14. The baggage caster lock device according to claim 1, wherein said wheel halting mechanism comprises:
a driving traction bar vertically extending into a chamber formed in said receptacle through a base panel of said caster, an upper end of the driving traction bar being coupled to a distal end of said transmission element so that the driving traction bar can vertically move in unison with the movement of said transmission element;
an oscillating lever pivotally supported by wheel supports of said caster at one end of the oscillating lever and pivotally coupled to a lower end of said driving traction bar at the other end of the oscillating lever;
a driven traction bar having an upper end pivotally supported by the center in the longitudinal direction of said oscillating lever, said driven traction bar being vertically movable in the same direction as said driving traction bar when said oscillating lever oscillates according to the movement of said driving traction bar;
a brake pad coupled to a lower end of said driven traction bar and adapted to be pressed against the inner surface of the wheel of said caster; and
a restoring means resiliently biasing said driving traction bar to allow said brake pad to move away from the inner surface of said wheel.

15. The baggage caster lock device according to claim 1, wherein said wheel halting mechanism comprises:
a driving traction bar vertically extending into a chamber formed in said receptacle through a passage defined through a base panel of said caster, an upper end of the driving traction bar being coupled to a distal end of said transmission element so that the driving traction bar can vertically move in unison with the movement of said transmission element;
an oscillating lever pivotally supported by wheel supports of said caster at the center in the longitudinal direction of the oscillating lever and pivotally coupled to a lower end of said driving traction bar at one end of the oscillating lever;
a pressing bar having an upper end pivotally supported by the other end of said oscillating lever, said pressing bar being vertically movable in the opposite direction to said driving traction bar when said oscillating lever oscillates according to the movement of said driving traction bar;
a brake pad coupled to a lower end of said pressing bar and adapted to be pressed against the outer surface of said wheel of said caster; and
a restoring means resiliently biasing said driving traction bar to allow said brake pad to move away from the outer surface of said wheel.

16. The baggage caster lock device according to claim 1, wherein said wheel halting mechanism comprises:
a driving traction bar vertically extending into a chamber formed in said receptacle through a base panel of said caster, an upper end of the driving traction bar being coupled to a distal end of said transmission element so that the driving traction bar can vertically move in unison with the movement of said transmission element;
an oscillating lever pivotally supported by wheel supports of said caster at the center in the longitudinal direction of the oscillating lever and pivotally coupled to a lower end of said driving traction bar at one end of the oscillating lever;
a pressing bar having an upper end pivotally supported by the other end of said oscillating lever, said pressing bar being vertically movable in the opposite direction to said driving traction bar when said oscillating lever oscillates according to the movement of said driving traction bar;
a brake pad coupled to a lower end of said pressing bar and adapted to be pressed against the outer surface of said wheel of said caster at a slightly diagonally upper position, and
a restoring means resiliently biasing said driving traction bar to allow said brake pad to move away from the outer surface of said wheel.

17. The baggage caster lock device according to claim 1, wherein said wheel halting mechanism comprises:
a driving traction bar vertically movable in an operation chamber formed inside said receptacle of said baggage above the position where said caster is mounted and linked to an end of said pulling force transmission mechanism,
an oscillating lever rotatably supported within said installation chamber and at an end of which said driving traction bar is pivotally supported,
a pressure halt bar pivotally supported by said oscillating lever in a vertically movable manner, extending through the base of said caster at the center of the rotation plane at the base of said caster to move up and down in the opposite direction to said driving traction bar as said oscillating lever oscillates, and having a lower end arresting the outer surface of said wheel of said caster, and
a restoring part resiliently biasing said driving traction bar to move said pressure halt bar away from the outer surface of said wheel.

18. The baggage caster lock device according to claim 17, wherein in said wheel halting mechanism, said operation chamber is continued from said installation chamber as an integrated compartment and said oscillating lever is positioned closer to said operation chamber and pivotally supported within said installation chamber.

19. The baggage caster lock device according to claim 1, wherein said wheel halting mechanism comprises a slide cord coupled to said pulling force transmission mechanism in the manner that it slides back and forth within an installation chamber formed inside said receptacle of said baggage above the position where said caster is mounted, a pressing member coupled to said slide cord and having a bottom surface gradually inclined downward toward the rear end of said slide cord to form a sliding surface, an oscillated lever oscillating downward as said sliding surface of the pressing member slides forward, a pressure halt bar extending through the base of said caster at the center of the rotation plane at the base of said caster and having a lower end arresting the outer surface of said wheel of said caster, and a restoring part resiliently biasing said pressure halt bar to move said pressure halt bar away from the outer surface of said wheel.

20. The baggage caster lock device according to claim 19, wherein in said wheel halting mechanism, a brake pad pressing on the outer surface of said wheel of said caster is coupled to the lower end of said pressure halt bar.
